(19) United States
(12) Patent Application Publication
(10) Pub. No.: US 2004/0226234 A1
(43) Pub. Date: Nov. 18, 2004

(54) Hung window with snap-fit assembly

(76) Inventor: Helmut Schmidt, Unionville (CA)

Correspondence Address: NIXON & VANDERHYE, PC, 1100 N GLEBE ROAD, 8TH FLOOR, ARLINGTON, VA, 22201-4714, US

(21) Appl. No.: 10/616,963

(22) Filed: Jul. 11, 2003

Related U.S. Application Data
(60) Provisional application No. 60/470,897, filed on May 16, 2003.

(51) Int. Cl. E06B 3/32

(52) U.S. Cl. 52/205

(57) ABSTRACT

A window assembly which includes at least some components which may be assembled in a snap-fit manner. In certain example embodiments, a combination of rotation/pivoting insertion, and a snap-fit assembly engagement of one or more components may be utilized in assembly. For example, a component may be engaged with a portion of another component, and then rotated and/or pivoted about a pivot axis until a portion of the component becomes engaged with a part of the window in a snap-fit manner. The combined use of rotation/pivoting about a pivot axis and snap-fit engagement allows for self-alignment to be realized during assembly thereby simplifying the assembly process.

This application claims priority on U.S. Provisional Application No. 60/470,897, filed May 16, 2003 (attorney reference 3691-556), the disclosure of which is hereby incorporated herein by reference.

This application relates to a window which may be assembled using a plurality of snap-fitting components. In certain example embodiments a single-hung window or the like may be assembled via a plurality of snap-fit steps. Such windows, which may be molded in certain example embodiments, may be used in the context of door windows, solarium windows, cottage windows, shed windows, residential home windows, and/or the like.

### BACKGROUND OF THE INVENTION

Hung windows are known in the art. For example, certain hung windows include a fixed glazing and a mobile glazing, where the mobile glazing may be moved relative to the fixed glazing during operation, repair or the like.

Unfortunately, certain components of typical window assemblies are often held together by fasteners which may require special tools to install/remove, and/or which lead to time-consuming assembly.

Certain snap-fit assemblies are also known in the window art. For example, see U.S. Pat. Nos. 4,753,056; 5,692,349 and 5,836,119, all of which are hereby incorporated herein by reference. Unfortunately, the snap-fit assemblies of these patents are often undesirable for one or more reasons such as alignment problems, efficiency of assembly problems, durability and/or longevity problems of the assembled product, security problems, and/or the like.

It will be appreciated by those skilled in the art that there exists a need in the art for a snap-fit window assembly design which is at least one of: (a) easy to assemble, (b) capable of realizing good security, (c) capable of providing self-alignment during assembly of components, and/or (d) durable and capable of realizing longevity.

### BRIEF SUMMARY OF THE INVENTION

This invention relates to a window assembly which includes at least some components which may be assembled in a snap-fit manner. The need for fasteners may be reduced and/or eliminated in certain embodiments.

In certain example embodiments, a combination of (i) rotation/pivoting insertion, and (ii) snap-fit assembly of one or more components is utilized. For example, a component may be engaged with a portion of another component, and then rotated and/or pivoted about a pivot axis until a portion of the component becomes engaged with a part of the window in a snap-fit manner. The combined use of rotation/pivoting about a pivot axis with snap-fit engagement has surprisingly been found to allow for self-alignment to be realized during assembly.

In certain example embodiments of this invention, there is provided a window comprising: a glazing at least partially supported by, and located partially between, first and second sash frames; and wherein the first sash frame comprises pivot means for pivotal engagement with the second sash frame, and snap-fit engagement means for snap-fit engagement with the second sash frame, so that said pivot means and snap-fit engagement means are for permitting the first sash frame to be attached and/or removed from the second sash frame by way of pivoting and snap-fit engagement and/or removal.

In other example embodiments of this invention, there is provided a window comprising: a glazing at least partially supported by, and located partially between, a mask and a frame member, each of the mask and frame member having an opening defined in a central area thereof; and wherein at least one of the mask and frame member comprises pivot means for pivotal engagement with the other of the mask and frame member, and snap-fit engagement means for snap-fit engagement with the other of the mask and frame member, so that said pivot means and snap-fit engagement means are for permitting said one of the mask and frame member to be attached and/or removed from the other of the mask and frame member by way of pivoting and snap-fit engagement and/or removal.

In still further example embodiments of this invention, there is provided a window comprising: a glazing at least partially supported by, and located partially between, first and second sash frames; a screen structure comprising a screen and a peripheral wall, wherein the screen structure is supported by at least a frame and/or mask member; and wherein the screen structure comprises pivot means for pivotal engagement with part of the window, and snap-fit engagement means for snap-fit engagement with the frame and/or mask member, so that said pivot means and snap-fit engagement means are for permitting the screen structure to be attached and/or removed from the frame and/or mask member by way of pivoting and snap-fit engagement and/or removal.

In still further example embodiments of this invention, there is provided a method of assembling a window, the method comprising: providing a glazing which is at least partially supported by a frame member; and pivotally engaging a mask with part of the frame member or a component supported by the frame member so as to define a pivot axis, and pivoting the mask about the pivot axis until another portion of the mask engages the frame member or a component supported by the frame member so as to provide a snap-fit connection between the mask and the frame member or a component supported by the frame member, with the glazing being located at least partially between at least part of the mask and at least part of the frame member.

In other example embodiments of this invention, there is provided window comprising: a fixed glazing at least partially covered by at least part of a fixed glazing mask; a movable glazing supported by, and located partially between, a movable glazing mask and a frame member, each of the movable glazing mask and frame member having an opening for viewing defined in a central area thereof; and wherein the movable glazing mask comprises pivot means for pivotal engagement with part of the fixed glazing mask so that when the pivot means of the movable glazing mask is engaged with the part of the fixed glazing mask the movable glazing mask is substantially pivoted about a pivot axis toward a final position; and wherein a screen structure is provided over at least part of the movable glazing mask, so that at least part of the movable glazing mask is located between respective parts of the screen structure and the movable glazing.

Any one of the example embodiments discussed above may or may not be used in combination with other of the example embodiments discussed above.

Each of the above-listed example embodiments may or may not be used in connection with other of the embodiments, in different aspects of the instant invention.

### BRIEF DESCRIPTION OF THE DRAWINGS

FIG. 1 is an exploded perspective view of various components of a window assembly which are to be assembled in making a window according to an example embodiment of this invention.

FIG. 2 is a schematic diagram illustrating the exterior sash frame being attached to at least the interior sash frame in a snap-fit manner according to an example embodiment of this invention.

FIG. 3 is a schematic diagram illustrating the exterior mask being attached to at least the exterior main frame in a snap-fit manner according to an example embodiment of this invention.

FIG. 4 is a schematic diagram illustrating the assembled sash being inserted into at least the exterior main frame in a pivoting manner and retained thereby according to an example embodiment of this invention.

FIG. 5 is a schematic diagram illustrating attachment of the mask of the mobile sash to at least the exterior main frame, where end portion(s) of the mask engage structure proximate and/or at the mullion of the exterior main frame (e.g., the structure may be part of the fixed glazing mask in certain example instances) to provide a pivot axis about which the mask pivots so that barb(s) of the mask can engage respective recess(es) defined in the exterior main frame in a snap-fit manner; thereby allowing the mask to substantially lock and/or hold at least the assembled sash in place.

FIG. 6 is a schematic diagram illustrating attachment of the insect screen structure, wherein end portion(s) of the screen structure engage structure proximate and/or at the mullion of the exterior main frame to provide a pivot axis about which the screen pivots so that barb(s) of the screen structure can engage respective recess(es) defined in the sash mask in a snap-fit manner; thereby allowing the screen structure to be attached to at least the sash mask.

FIG. 7 is a schematic diagram illustrating attachment of the interior main frame to at least the exterior main frame.

FIG. 8 is a vertical cross sectional view of a resulting window assembly (viewed from the side of the window) assembled in accordance with FIGS. 1-7 according to an example embodiment of this invention, where the fixed glazing is at a top portion of the figure and the mobile glazing is at the bottom portion of the figure.

FIG. 9a is a horizontal cross sectional view of the fixed glazing portion of the window of FIG. 8 (viewed from above).

FIG. 9b is a horizontal cross sectional view of the mobile sash portion, sash mask and insect screen of FIG. 8 (viewed from above).

### DETAILED DESCRIPTION OF EXAMPLE EMBODIMENTS OF THE INVENTION

Referring now more particularly to the accompanying drawings in which like reference numerals indicate like parts throughout the several views.

Certain example embodiments of this invention relate to window structures which utilize at least some snap-fit components. In certain example embodiments, a combination of (i) rotation/pivoting insertion, and (ii) snap-fit assembly of one or more components is utilized in assembling at least one component of the window. For example, a component may be engaged with a portion of another component, and then rotated and/or pivoted about a pivot axis until a portion of the component becomes engaged with another part in a snap-fit manner. The combined use of rotation/pivoting about a pivot axis and snap-fit engagement has surprisingly been found to allow for self-alignment to be realized during assembly. Thus, assembly of the window is easier, more efficient, less time consuming, and/or leads to fewer assembly-related problems (e.g., potential for misalignment is reduced). When a sash component is attachable (e.g., insertable) in such a manner, for example and without limitation, this may be advantageous in that the need for special attachment tools may be avoided and/or reduced, the sash component may be easily removable, and/or the sash component may be easily repairable.

In certain example embodiments, the snap-fit attachments may only be accessible from the interior of the window/building/door, and/or if the sash has been raised or removed. Each of these ways in which the snap-fit attachments may be accessed is based upon access or actions taken on the interior side of the window, thereby allowing for good security to be realized.

Windows according to certain example embodiments of this invention may be used in the context of door windows which may be used in garage doors or any other type of doors, solarium windows, cottage windows, home windows, or in any other suitable window application. Certain example embodiments of this invention relate to single-hung molded windows, although certain embodiments of this invention may be used in the context of other types of windows.

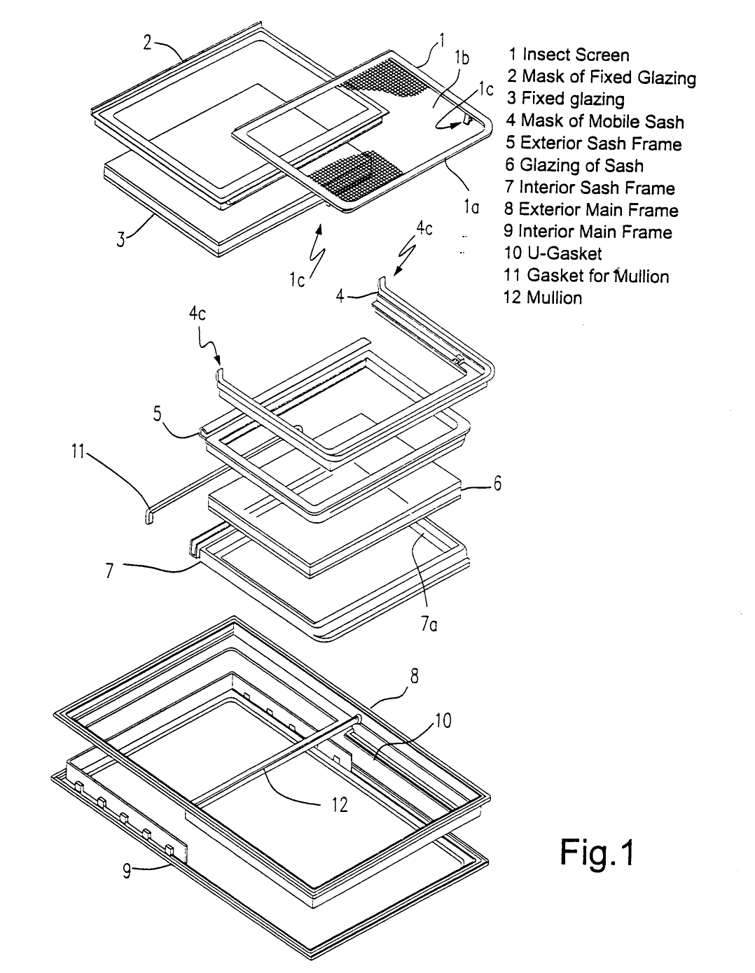

FIG. 1 is an exploded view illustrating certain components of a window to be assembled according to an example embodiment of this invention. The components are illustrated in color in all figures except for FIG. 1 for purposes of simplicity and ease of understanding. The window includes insect screen 1, fixed glazing mask 2, fixed glazing 3, mobile sash mask 4, exterior sash frame 5, glazing 6, interior sash frame 7, exterior main frame 8, interior main frame 9, U-shaped gasket 10, mullion gasket 11, and mullion 12 which extends between opposing sides and/or edges of the frame 8 for support purposes and the like. In certain example embodiments, mask 2 at least partially covers a peripheral edge portion of glazing 3, and mask 4 at least partially covers a peripheral edge portion of glazing 6.

In certain example embodiments of this invention, each glazing 3 and 6 may be of the insulating glass (IG) window type so as to include a pair of spaced apart glass or plastic sheets. For example, glazing 3 as shown in other figures may include a pair of glass sheets 3a and 3b with space 3c defined therebetween. The space 3c may be filled with gas (e.g., argon) in certain example embodiments, although it need not be. In certain example embodiments, the space 3c may be at a pressure less than atmospheric, although it need not be in other embodiments. In a similar manner, glazing 6 may include a pair of glass sheets 6a and 6b with space 6c defined therebetween. While IG units are preferred in certain embodiments of this invention, other glazings may instead be used in other embodiments of this invention.

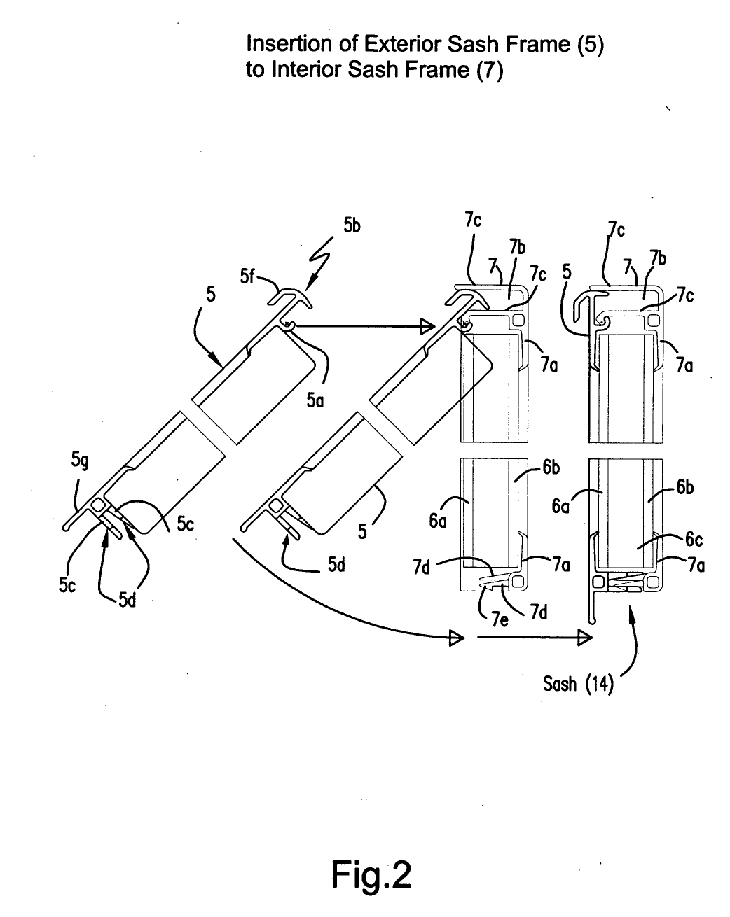

A color chart is set forth below for indicating the colors of certain components as shown in FIG. 2-9. Again, these colors have nothing to do with the final product herein, but are used in this application/patent for purposes of understanding and clarity of illustration.

Color Chart for FIGS. 2-9

| Component | Color |
|---|---|
| Insect Screen 1 | Blue |
| Fixed Glazing Mask 2 | Red |
| Fixed Glazing 3 | Blue |
| Mobile Sash Mask 4 | Black |
| Exterior Sash Frame 5 | Orange/Red |
| Glazing of Sash 6 | Blue |
| Interior Sash Frame 7 | Pink/Red |
| Exterior Main Frame 8 | Green |
| Interior Main Frame 9 | Red |

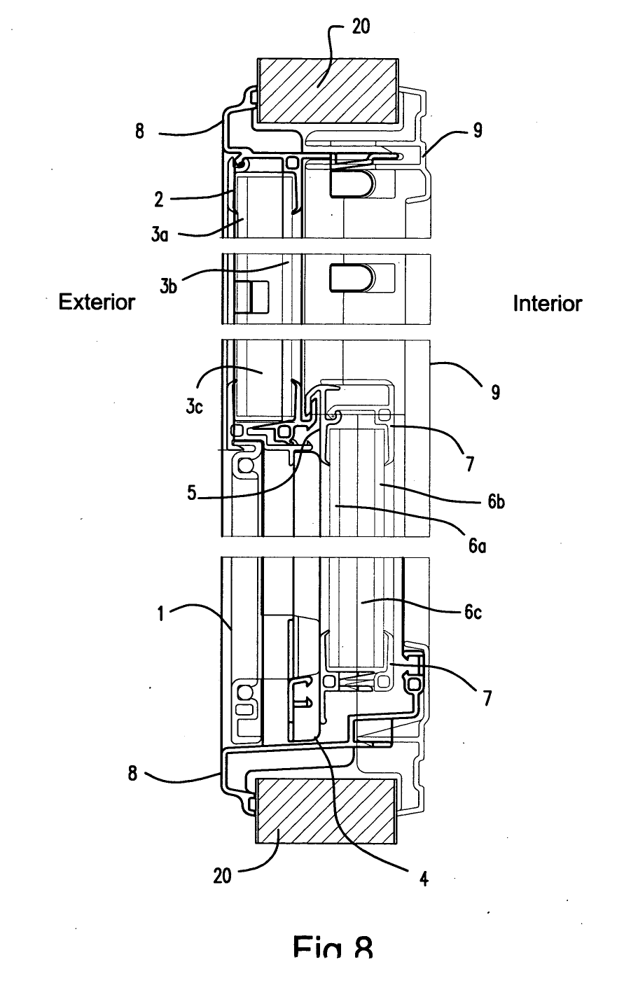

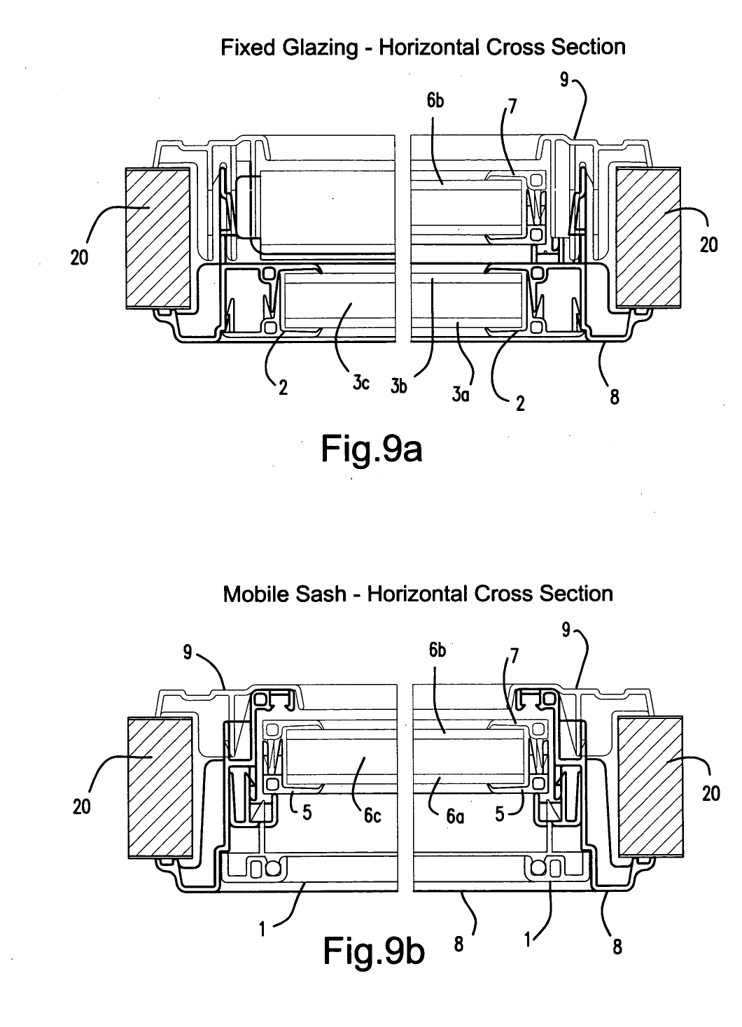

FIGS. 8-9 illustrate a window according to an example embodiment of this invention. FIG. 8 is a vertical cross sectional view of a resulting window assembly (viewed from the side of the window) where the fixed glazing is at a top portion of the figure and the mobile glazing is at the bottom portion of the figure. FIG. 9a is a horizontal cross sectional view of the fixed glazing portion of the window of FIG. 8 (viewed from above), and FIG. 9b is a horizontal cross sectional view of the mobile sash portion, sash mask and insect screen of FIG. 8 (viewed from above). It can be seen in FIGS. 8-9 that the window is installed for attachment to structure 20, with fixed glazing 3 and mobile (movable) glazing 6 being sandwiched between at least portions of exterior main frame 8 and interior main frame 9. The use of pivoting/rotation and snap-fit engagements in the window will be more fully explained below during description of the example technique for assembly shown in the other figures.

FIGS. 2-7 illustrate various steps undertaken during the method of assembling/making the window of FIGS. 8-9. This example method of assembly, with reference to FIGS. 2-7, is for purposes of example only and is not intended to be limiting unless claimed.

FIG. 2 is a schematic diagram illustrating the exterior sash frame 5 being attached to at least the interior sash frame 7 in a snap-fit manner according to an example embodiment of this invention. Each sash frame 5, 7 has an opening or window (vision area) area defined in a central portion thereof (e.g., see FIG. 1). Referring to FIG. 2, it can be seen that glazing 6 is supported by interior sash frame 7. For example, the interior sash frame 7 may include support portion(s) 7a for supporting the glazing 6. Moreover, interior sash frame 7 may also include a channel 7b defined by a pair of approximately parallel side walls 7c, and first and second projections 7d including respective barbs 7e thereon for engagement with the exterior sash frame 5. Meanwhile, exterior sash frame 5 may include hook-shaped member 5a, approximately T-shaped edge support 5b, and first and second projections 5c including respective barbs 5d thereon for engagement with the interior sash frame 7.

In order to attach the exterior sash frame 5 to the interior sash frame 7, the hook-shaped member 5a of the exterior sash frame is engaged with an end of the inner side wall 7c of the interior sash frame having a protrusion thereon thereby defining a pivot axis (see the pivot axis “+” in FIG. 2) about which the exterior sash frame 5 is to approximately rotate/pivot during installation and/or removal. Once the hook-shaped member 5a is engaged, the exterior sash frame 5 is pivoted about axis + as shown by the arrows in FIG. 2 until the barbs 5d supported by projections 5c engage with opposing barbs 7e supported by projections 7d of the interior sash frame in a snap-fit manner. Thus, it can be seen that the snap-fit engagement is realized by the opposing barbs 5d, 7e and/or projections 5c, 7d of the exterior and interior sash frames, and the undercuts defined by the barbs supported by the projections. The assembled sash 14 is shown at the right-hand portion of FIG. 2. The sash frames may be disassembled by reversing these steps.

In alternative embodiments of this invention, only one projection and barb may be provided per sash frame, whereas in still further embodiments a barb from one of the sash frames 5, 7 may engage a recess in the other sash frame in order to accomplish to snap-fit attachment of sash frame 5 to sash frame 7. Such alternatives apply to all snap-fit connections herein in alternative embodiments of this invention.

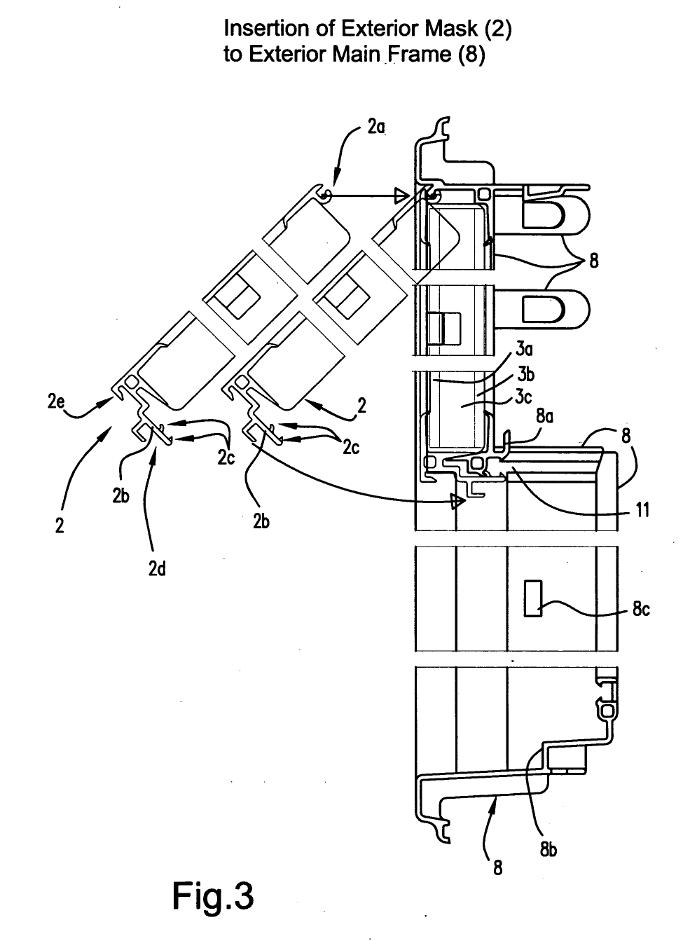

FIG. 3 is a schematic diagram illustrating the exterior mask 2 being attached to at least the exterior main frame 8 in a snap-fit manner according to an example embodiment of this invention. This may be done before and/or after the FIG. 2 assembly of the sash is completed. Each of mask 2 and exterior main frame 8 has an opening or window area defined in a central portion thereof (e.g., see FIG. 1).

Referring to FIG. 3, the fixed glazing mask 2 includes curved and hook-shaped member 2a proximate an end thereof, and an elongated projection 2b proximate an opposite end thereof which has one or more barbs 2c thereon for engagement with the exterior main frame 8. In order to attach the mask 2 to the exterior main frame 8, the hook-shaped member 2a of the mask is engaged with a projection extending from part of the exterior main frame 8 thereby defining a pivot axis as shown in FIG. 3 about which the mask 2 is to approximately rotate/pivot during installation and/or removal. Once the hook-shaped member 2a is engaged, the mask 2 is pivoted about the pivot axis defined within part of the hook shaped member 2a as shown by the arrow in FIG. 3 until at least one barb 2c supported by projection 2b engages with an opposing barb and/or recess defined on or in the exterior main frame 8 (as shown in FIG. 3) or some other part of the window. Thus, due to the engagement of barb(s) 2c, the mask 2 is attached to the frame 8 in a snap-fit manner. As will be appreciated by those skilled in the art, the mask 2 may be removed by reversing these steps.

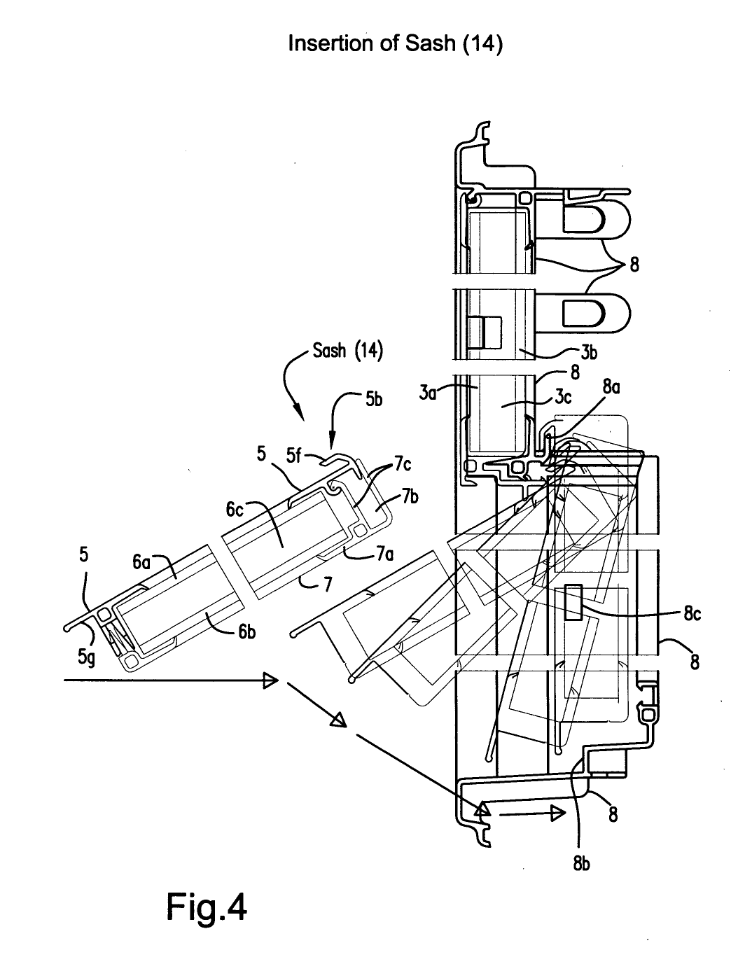

FIG. 4 is a schematic diagram illustrating the assembled sash 14 (assembled in FIG. 2) being attached to at least the exterior main frame 8 in a pivoting manner according to an example embodiment of this invention. At least one of the extensions 5f of the approximately T-shaped edge support 5b of exterior sash frame 5 includes an approximately curved and hook shaped end portion. In order to attach the sash 14 to the exterior main frame 8 (e.g., insert the sash 14 into the exterior main frame 8), it can be seen that this approximately hook-shaped end portion of extension 5f is engaged with at least an end of a projection 8a extending from part of the exterior main frame thereby defining a pivot axis within the hook-shaped end portion about which the sash 14 is to approximately rotate/pivot during installation and/or removal. Once the hook-shaped end portion of extension 5f is engaged, the sash 14 is pivoted about the pivot axis as shown in FIG. 4 until the sash is located within at least part of the exterior main frame 8 so that the glazing 6 is approximately parallel to glazing 3. There need not be any snap-fit attachment of the sash 14 to the exterior main frame 8 in this example embodiment (although it is possible in certain embodiments, but not shown in the figures herein). In certain example embodiments, ledge 8b may engage projection 5g in order to prevent the sash 14 from moving too far. Moreover, significant lateral and/or vertical movement in one direction is prevented by the engagement of the hook-shaped end portion of extension 5f with the end of projection 8a of the frame 8.

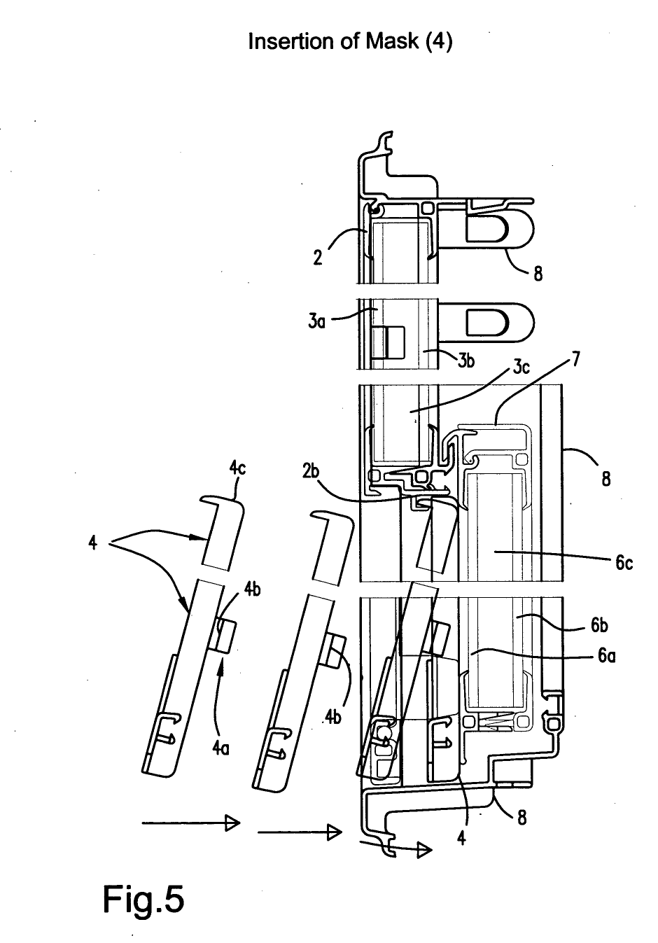

FIG. 5 is a schematic diagram illustrating attachment of the mask 4 of the mobile sash 14 to at least the exterior main frame 8, where end portion(s) of the mask 4 engage structure proximate and/or at the mullion of the exterior main frame to provide a pivot axis about which the mask pivots so that barb(s) of the mask 4 can engage respective recess(es) defined in the exterior main frame in a snap-fit manner; thereby allowing the mask 4 to substantially lock and/or hold at least the assembled sash 14 in place within frame 8. It can be seen in FIG. 5 that mask 4 includes one or more projections 4a having a barb(s) 4b thereon for engagement with the frame 8.

Still referring to FIG. 5, in order to attach the mobile sash mask 4 to at least the exterior main frame 8, curved end portions 4c (see FIGS. 1 and 5) of the approximately U-shaped mask 4 are engaged proximate the mullion of the frame 8 in a cavity and/or step defined by a substantially U-shaped portion 2d at least partially defined by projection 2b of the fixed glazing mask 2 thereby defining a pivot axis as shown in FIG. 5 about which the mask 4 is to approximately rotate/pivot during installation and/or removal. Once the curved end portions 4c have been engaged, the mask 4 is pivoted about the pivot axis as shown in FIG. 5 until at least one barb 4b supported by a projection 4a engages with an opposing barb and/or recess 8c defined on or in the exterior main frame 8 (note: recess 8c is best shown in FIGS. 3-4 for purposes of simplicity), or some other part of the window. Thus, due to the engagement of barb(s) 4b, the mask 4 is attached to the frame 8 in a snap-fit manner to substantially lock and/or hold at least the assembled sash 14 in place within at least part of the frame 8. It is noted that herein, the word “pivoting” covers both exact pivoting and approximate pivoting, as it can be seen that some pivot axes herein may move during rotational movement of components being pivoted. The mask 4 may be removed by reversing these steps.

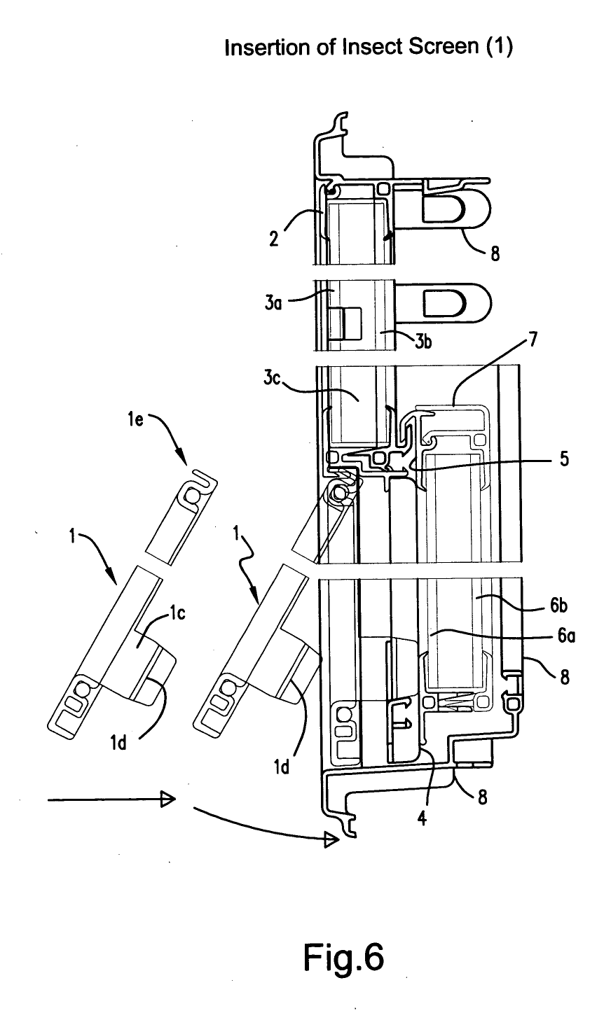

FIG. 6 is a schematic diagram illustrating attachment of the insect screen structure 1, wherein end portion(s) of the screen structure engage structure proximate and/or at the mullion of the exterior main frame 8 to provide a pivot axis about which the screen pivots so that barb(s) of the screen structure can engage respective recess(es) or the like defined in the sash mask 4 in a snap-fit manner; thereby allowing the screen structure to be attached to at least the sash mask 4 and/or other window component. Screen structure 1 includes a peripheral frame 1a, screen portion 1b, and one or more projections 1c supporting barbs 1d as shown in FIGS. 1 and 6. Moreover, the screen structure includes a curved and approximately hook-shaped end portion 1e for engagement with structure proximate the mullion of the frame 8. In order to attach the screen structure 1 to the window structure, curved and hook-shaped end portion 1e of the screen structure is engaged proximate the mullion of the frame 8 in a cavity defined by an approximately U-shaped portion 2e (see FIGS. 3 and 6) of fixed glazing mask 2 thereby defining a pivot axis as shown in FIG. 6 about which the screen structure 1 is to approximately rotate/pivot during installation and/or removal. Once the hook-shaped end portion 1e has been engaged, the screen structure 1 is pivoted about the pivot axis as shown in FIG. 6 until at least one barb 1d supported by a projection 1c engages with a wall, barb and/or recess defined by sash mask 4 as best shown in FIGS. 1 and 6. Thus, due to the engagement of barb(s) 1d, the screen structure 1 is attached to the frame 8 via the sash mask 4 in a snap-fit manner and/or via mask 2, over at least part of the mask 4.

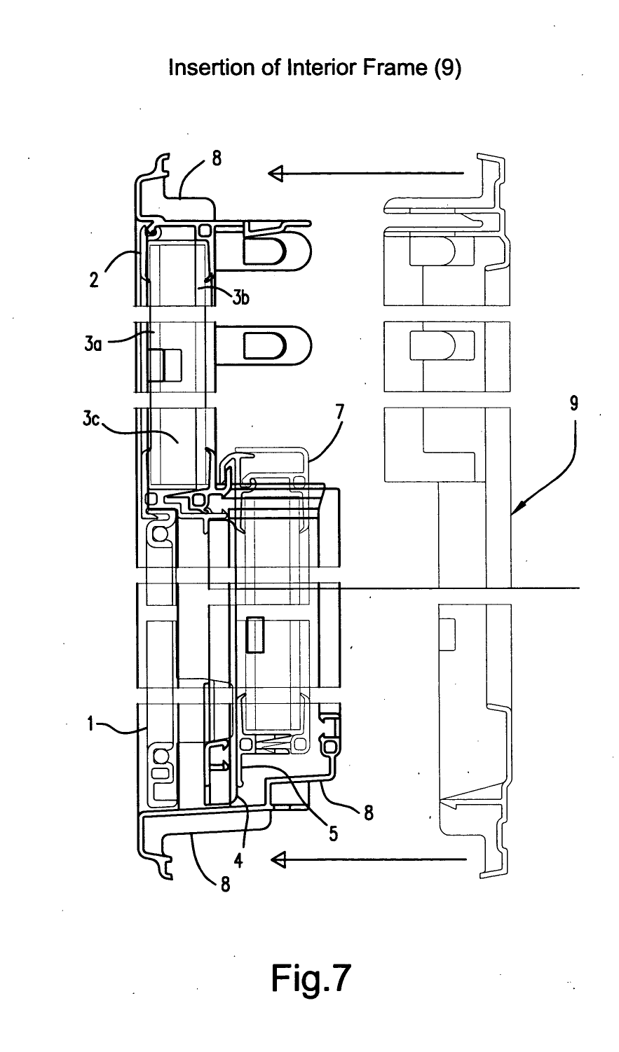

Thereafter, the window structure of FIG. 6 may be shipped to customers or the like and installed in doors, walls, and/or the like. After installation of the window structure of FIG. 6 in a door or wall, interior main frame 9 is attached to the exterior main frame 8 as shown in FIG. 7. As explained above, the snap-fit attachments may only be accessible from the interior of the window/building/door, and/or if the sash has been raised or removed. Each of these ways in which the snap-fit attachments may be accessed is based upon access or actions taken on the interior side of the window, thereby allowing for good security to be realized. Example final window products are illustrated in FIGS. 8-9 as discussed above.

Various components of this invention may be made of different materials in different embodiments of this invention. However, in certain example embodiments, components such as masks 2 and/or 4, frame portions 5, 7, 8 and/or 9, may be made of or include polymer materials such as PVC, PP, and/or the like. Other polymer based materials may instead be used in other embodiments. Solid portions of the illustrated components may be formed by injection molding in certain embodiments of this invention.

The embodiment discussed above is for purposes of example. Thus, in other example embodiments of this invention, the male/female components for defining pivot means and snap-fit engagement means can be switched between components. As an example, in the FIG. 2 embodiment, the hook-shaped member for the pivot means could be provided on frame 7 instead of frame 5. As another example, in the FIG. 3 embodiment, the hook-shaped member for the pivot means could be provided on frame 8 instead of mask 2. Moreover, the different snap-fit engagement structures defined herein and the different pivoting structures defined herein may or may not be used in combination with each other in different embodiments of this invention. For purposes of example only, and without limitation, the FIG. 2 system may be provided but not the FIG. 3 system in certain example embodiments of this invention, and vice versa. As another example, the FIG. 4 system may be provided but not the FIG. 2 and/or 3 system in certain example embodiments of this invention, and vice versa. As yet another example, the FIG. 5 system may be provided but not the FIG. 2, 3 and/or 4 system(s) in certain example embodiments of this invention, and vice versa; and so forth. Moreover, in still further example embodiments of this invention, male and female aspects may be provided on the same part in certain example instances.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A window comprising:
a glazing at least partially supported by, and located partially between, first and second sash frames; and
wherein the first sash frame comprises pivot means for pivotal engagement with the second sash frame, and snap-fit engagement means for snap-fit engagement with the second sash frame, so that said pivot means and snap-fit engagement means are for permitting the first sash frame to be attached and/or removed from the second sash frame by way of pivoting and snap-fit engagement and/or removal.

2. The window of claim 1, wherein the pivot means is a hook-shaped member of the first sash frame, and wherein the hook-shaped member of the first sash frame engages an end of a projection of the second sash frame so that a pivot axis about which the first sash frame pivots is partially surrounded by the hook-shaped member.

3. The window of claim 1, wherein the snap-fit engagement means of the first sash frame comprises at least one projection which supports a barb, wherein the barb is for engagement with a recess and/or opposing barb of the second sash frame.

4. The window of claim 1, wherein the snap-fit engagement means of the first sash frame comprises first and second projections which support at least first and second barbs, respectively, wherein the first and second projections are for engagement with respective recesses and/or opposing barbs of the second sash frame.

5. The window of claim 1, wherein the second sash frame includes a channel defined between first and second approximately parallel side walls, and wherein said pivot means of the first sash frame engages with at least one of the side walls.

6. A window comprising:
a glazing at least partially supported by, and located partially between, first and second sash frames; and
wherein the first sash frame comprises a curved member for pivotal engagement with the second sash frame, and at least one barb for snap-fit engagement with the second sash frame, so that at least said curved member and barb permit the first sash frame to be attached and/or removed from the second sash frame by a combination of pivoting and snap-fit engagement and/or removal.

7. The window of claim 6, wherein the second sash frame includes a channel defined between first and second approximately parallel side walls, and wherein said curved member of the first sash frame engages with at least one of the side walls in order to define a pivot axis about which the first sash frame can pivot.

8. A window comprising:
a glazing at least partially supported by, and located partially between, a mask and a frame member, each of the mask and frame member having an opening defined in a central area thereof; and
wherein at least one of the mask and frame member comprises pivot means for pivotal engagement with the other of the mask and frame member, and snap-fit engagement means for snap-fit engagement with the other of the mask and frame member, so that said pivot means and snap-fit engagement means are for permitting said one of the mask and frame member to be attached and/or removed from the other of the mask and frame member by way of pivoting and snap-fit engagement and/or removal.

9. The window of claim 8, wherein the frame member is an exterior main frame member.

10. The window of claim 8, wherein the mask is a mask for at least partially covering a peripheral area of the glazing.

11. The window of claim 8, wherein the pivot means is a hook-shaped member, wherein the hook-shaped member of said one of the mask and frame member engages an end of a projection of the other of the mask and frame member so that a pivot axis about which said one of the mask and frame member pivots is partially surrounded by the hook-shaped member.

12. The window of claim 8, wherein said pivot means is provided on the mask.

13. A window comprising:
a glazing at least partially supported by, and located partially between, a mask and a frame member, each of the mask and frame member having an opening defined in a central area thereof; and
wherein at least one of the mask and frame member comprises a pivot structure for pivotal engagement with the other of the mask and frame member, and snap-fit engagement structure for snap-fit engagement with the other of the mask and frame member, so that said pivot and snap-fit engagement structures permit said one of the mask and frame member to be attached and/or removed from the other of the mask and frame member by way of pivoting and snap-fit engagement and/or removal.

14. A window comprising:
a glazing at least partially supported by, and located partially between, first and second sash frames;
a screen structure comprising a screen and a peripheral wall, wherein the screen structure is supported by at least a frame and/or mask member; and
wherein the screen structure comprises pivot means for pivotal engagement with part of the window, and snap-fit engagement means for snap-fit engagement with the frame and/or mask member, so that said pivot means and snap-fit engagement means are for permitting the screen structure to be attached and/or removed from the frame and/or mask member by way of pivoting and snap-fit engagement and/or removal.

15. The window of claim 14, wherein the pivot means is a hook-shaped member of the screen structure, and wherein the hook-shaped member of the screen structure engages an end of a projection of another component of the window so that a pivot axis about which the screen structure pivots is partially surrounded by the hook-shaped member.

16. A window comprising:
a glazing at least partially supported by, and located partially between, first and second sash frames;
a screen structure comprising a screen and a peripheral wall, wherein the screen structure is supported by at least a frame and/or mask member; and
wherein the screen structure comprises a curved and/or hook-shaped member for pivotal engagement with part of the window, and at least one snap-fit engagement barb for snap-fit engagement with part of the frame and/or mask member, so that said curved and/or hook-shaped member and said snap-fit engagement barb permit the screen structure to be attached and/or removed from the frame and/or mask member by way of pivoting and snap-fit engagement and/or removal.

17. A method of assembling a window, the method comprising:
providing a glazing which is at least partially supported by a first sash frame; and
pivotally engaging a second sash frame with part of the first sash frame so as to define a pivot axis, and pivoting the second sash frame about the pivot axis until another portion of the second sash frame engages the first sash frame in a snap-fit manner so as to provide a snap-fit connection between the first and second sash frames, with the glazing being located at least partially between the first and second sash frames.

18. A method of assembling a window, the method comprising:
providing a glazing which is at least partially supported by a frame member; and
pivotally engaging a mask with part of the frame member or a component supported by the frame member so as to define a pivot axis, and pivoting the mask about the pivot axis until another portion of the mask engages the frame member or a component supported by the frame member so as to provide a snap-fit connection between the mask and the frame member or a component supported by the frame member, with the glazing being located at least partially between at least part of the mask and at least part of the frame member.

19. A window comprising:
a fixed glazing at least partially covered by at least part of a fixed glazing mask;
a movable glazing supported by, and located partially between, a movable glazing mask and a frame member, each of the movable glazing mask and frame member having an opening for viewing defined in a central area thereof; and
wherein the movable glazing mask comprises pivot means for pivotal engagement with part of the fixed glazing mask so that when the pivot means of the movable glazing mask is engaged with the part of the fixed glazing mask the movable glazing mask is substantially pivoted about a pivot axis toward a final position;
wherein a screen structure is provided over at least part of the movable glazing mask, so that at least part of the movable glazing mask is located between respective parts of the screen structure and the movable glazing.
